(19) United States
(12) Patent Application Publication
(10) Pub. No.: US 2007/0266081 A1
(43) Pub. Date: Nov. 15, 2007

(54) Remotely managed lock or access point, via the Internet, to a distribution receptacle or secure location

(76) Inventors: Kenneth Murchison III, Dallas, TX (US); W. C. Chip Perryman III, Athens, TX (US)

Correspondence Address: JACKSON WALKER LLP, 901 MAIN STREET, SUITE 6000, DALLAS, TX, 75202-3797, US

(21) Appl. No.: 11/409,606

(22) Filed: Apr. 24, 2006

(51) Int. Cl. G06F 15/16

(52) U.S. Cl. 709/203

(57) ABSTRACT

A locking mechanism that is electronically managed or Hosted at a remote central location via the Internet or wireless communication network with conditional code validations. The remote management interface software resides on Host computer servers, which are in turn accessed and managed by Users through a common browser interface via the Internet or a wireless communication network via a wireless mobile device. The remote Host software provides a variety of robust options for the user of the local access point, to program multiple access codes with varying conditions of time, date and use occurrence limitations. Additionally, the Host software provides information, distributes codes, tracks and reports usage at the respective local access points. The Host interfaces with each unique local electronic locking mechanism at the respective local access location either via a web enabled device or a common PC based Internet browser or wireless mobile device.

### FIELD OF THE INVENTION

The present invention relates to controlling access to a controlled access point, and more particularly to locked locations and storage receptacles.

### BACKGROUND OF THE INVENTION

U.S. Pat. No. 5,774,053 to Porter which is hereby incorporated by reference, describes a storage device for the delivery and pickup of goods. As recognized in that disclosure, home delivery of goods has become more and more popular with the rise of shopping over the Internet, by catalog, and by local merchants. In addition to clothing, appliances, furniture, books and other materials previously available from catalogs and the like, the Internet has spawned e-shopping services for groceries and other items. Similarly, in many areas, local merchants such as dry cleaners offer residential pickup and delivery services for their customers.

The Porter storage device teaches a means for such home pickups and deliveries even when the homeowner was absent. The storage device provides a secure environment for the goods and included a communication apparatus for providing notification that the goods had been picked up or delivered. Access to the storage device may be gained by entering a so-called vendor code into a controller via a Keypad. The controller oversees locking/unlocking of the storage device. Entering a valid vendor code unlocks the storage device, allowing couriers and/or others to pickup and/or deliver goods from/to the storage device.

One shortcoming with the storage device described by U.S. Pat. No. 5,774,053 concerns the use of the vendor codes. As contemplated, the vendor codes are static, reusable codes assigned to each vendor that delivers and/or picks up goods to/from the storage device. For example, a laundry and dry cleaning business may be assigned a vendor code of 333, whereas a local grocery store may be assigned a vendor code of 444. The use of such vendor codes may present a security risk in that once an unauthorized person learns one of the codes, that individual has access to the storage device until such time as the code is removed from the list of authorized vendor codes stored in the controller's memory. This may present a problem inasmuch as several days or weeks may pass before a storage box owner learns that one or more of the vendor codes has been compromised and has time to reprogram the controller with new vendor codes. During this time, the security of the storage box is questionable at best. Moreover, the assigning, canceling and reassigning of the vendor codes requires what could be a significant amount of time and effort (key management) on the part of a storage device owner/end-user. Also, the vendors are required to keep track of codes for different customers and, presumably, must take steps to ensure that the security of these codes is maintained.

### SUMMARY OF INVENTION

The present invention achieves technical advantages as a device and system configured to electronically and remotely manage an access point such as a distribution receptacle, a secure location, or an unsecured access point.

In one embodiment of the present invention, a system core including a remote Host server, which is accessed by a User via the Internet or by a wireless communication network, is configured to manage access codes for an associated locking mechanism at a local access point. The Host may also track and report use at the access point whether it is secure or unsecured. The local user (“User”), being a homeowner, property manager or security personnel, for instance, utilizes the system. The User may create a single or multiple authorized codes and assign applicable time, date and recurrence limitations to each. The Host server issues to an authorized person, a merchant or delivery service (“Authorized Person”), valid access codes for the locking mechanism, wherein the access codes are issued from a list of currently valid codes for a respective locking mechanism. The Authorized Person enters the authorized code at the access point and the locking mechanism is actuated to open. The control unit at the locking mechanism in turn reports back electronically to the Host server all activity at the access point or Keypad. Such activity could include the code used, time, date, location, audio, video or other recorded multimedia data. This activity is tracked and logged by the Host, which is in turn reported back to the User. The 3^{rd} party Authorized Person is also transmitted a log of the activity limited to their usage.

The physical lock may be accessed via an electronic keypad that is either programmed manually at the keypad or managed remotely via an interface over the Internet based or a wireless communication network. The interface to the locking mechanism offers a great deal of flexibility. Through the interface, the authorized User is able to assign multiple valid access codes that can be limited to certain delivery Authorized Persons, of varying durations, or one time use that might be limited to a particular delivery. In this way, a User can allow access to the access point from a remote location using an Internet based or wireless mobile device interface. The keypad may also accommodate traditional hardware key to access the locking mechanism in the event of a power failure. The keypad may also be manually programmed to accommodate a master digital code, thus mitigating the need for an Internet connection, a wireless mobile device signal, or a lost hardware key.

Each keypad and/or User interface client software may have a unique electronic identification number (“EID”) assigned to each locking device. This EID enables the Host server to manage secure code authorizations associated with that lock's EID and access to each respective locking device. The Host also manages reporting and/or billing to the authorized User. It tracks each occurrence of an authorization or change of a code as well as the time and any other relevant data associated with each authorized use. Additionally the Host may track each unauthenticated attempt to access the device or appliance. The User is able to both manage access codes as well as track all use activity of the keypad or to an unsecured access point. Activity may be tracked either through a browser based interface to the management system database, by electronic data interchange (“EDI”), by a wireless mobile device or by periodic hard copy printout provided by the Host system manager to the User.

The User may additionally have the ability to assign a valid access code with its associated restrictions that is valid on a plurality of access points. This may be applicable in an apartment building with 150 units wherein the building superintendent needs access to all units with a single valid access code.

The interface may be managed or Hosted at a central location. It may reside on computer servers and interface with each unique access point through the Internet or a wireless mobile service to the remote location. At the local access point, a web enabled device, a wireless mobile device or client software provides a connection between the Host and the access point. The connection to the access point may be either via a hardwired connection such as a CAT-5 cable from the local Internet connection to the mechanism controller or by a wireless device such as a common wireless NIC, or by a wireless mobile device. Protection such as secure socket layer, public key/private key encryption can be incorporated into the Host server, local client software, web enabled device, wireless mobile device or keypad controller.

### BRIEF DESCRIPTION OF THE DRAWINGS

FIG. 1 depicts a block diagram and architecture of the invention operation.

### DETAILED DESCRIPTION OF THE PRESENT INVENTION

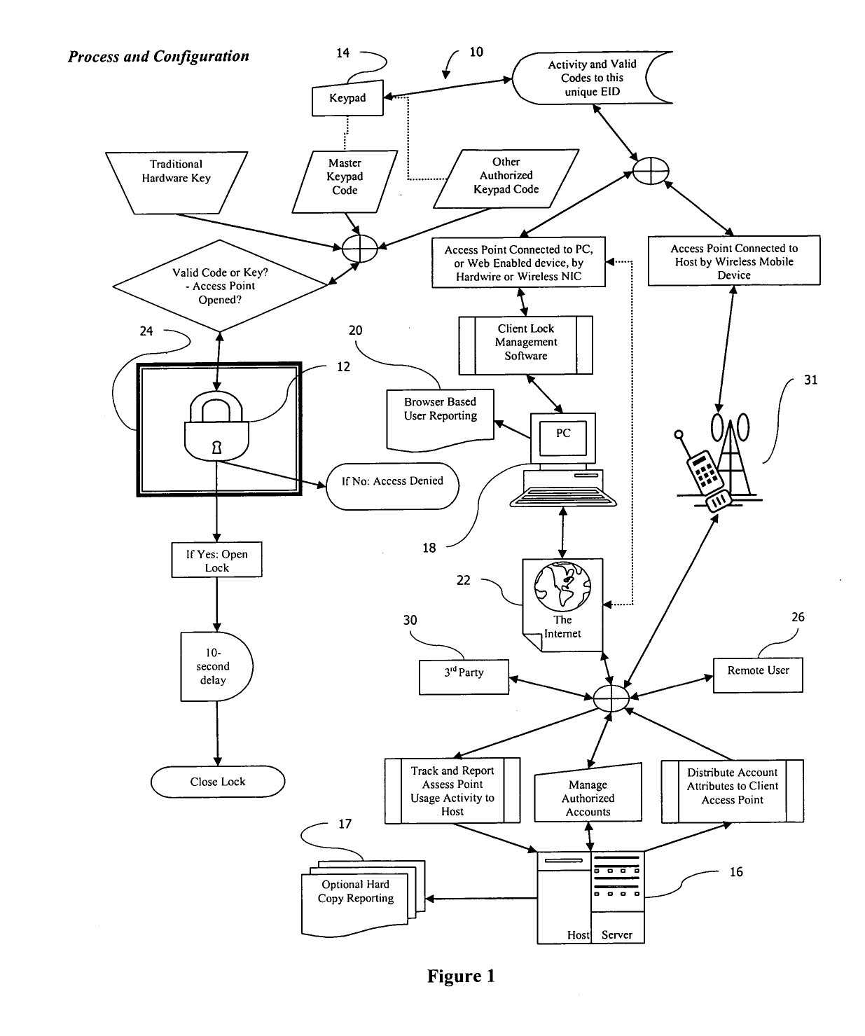

Referring now to FIG. 1, there is generally shown at 10 an overview of the present invention and environment for using same. System 10 is seen to include a controlled access point 12 and a physically remote Host 16 for facilitating controlling the access thereof from a physically remote location. A data entry module 14 that is at, or physically remote from, the access point 12 and Host 16 may be used to gain access to access point 12, and may be a keypad, card reader, wireless mobile device, RFID receiver, biometric sensor such as a finger print reader, or other mechanism for authenticating some type of electronic code to allow access to access point 12. Host 16 in one preferred embodiment is electronically coupled to access point 12 via the internet or a wireless communication network to control the configuration of access point 12, such as to provide electronic codes thereat which are valid codes for permitting access at access point 12. These codes can be established and have a plurality of parameters, such that they are valid according to both fixed and selectable parameters. For instance, some codes may be valid all the time, while others may be valid during certain times of the day, on certain days, or certain weeks, or even temporary codes. Such temporary codes may be provided to different vendors, such as pizza delivery services, swimming pool services, friends, visitors and so forth which will be described in more detail shortly.

One of the advantageous features of this system 10 is that verifications and reports can be generated, to create logs, for instance, of access at access point 12, attempted access, and as a function of keys entered, attempted keys used, and also to receive confirmations when such access was granted or denied, generally shown at 17. These reports can be stored locally at the Host 16 or at the access point, but also can be sent, or remotely accessed. The alerts can be provided to authorized persons, including the owner of system 10, via the internet as a message deliverable to a party, such as the user, a security monitoring agency, and so forth. Such messages may be sent as an email, an SMS text message and so forth to a computer, personal digital assistant (PDA), phone, wireless mobile device or other communication module. Such reported activity could include the code used, time, date, location, audio, video or other recorded multimedia data. Locally, the access point 12 may be controlled by a resident communication module 18 on site, or proximate the access point 12, which communication module 18 electronically communicates via a communication link with the remote Host server 16, such as via the internet or a wireless communication network, such as via a wireless mobile device 31. Reports of access, or attempted access, can be generated by the local communication terminal 18 as generally shown at 20.

Still referring now to FIG. 1, one embodiment of the invention may be shown an unattended, built in, secure delivery and storage appliance for the home or business, generally shown at 24. The appliance 24 combines a weatherproof and theft resistant built-in cabinet that is accessed by the electronic input module 14, such as a Keypad # or other electronic communication device operated locking mechanism. The Keypad 14 accommodates multiple access codes that are programmed either manually at the Keypad, or managed remotely over the internet 22 by the User via an Internet based interface to the Host server 16, or by a wireless communication network via a wireless mobile device 31 to the Host server 16.

The cabinet 24 may generally resemble a night depository box customarily seen at a bank or library. It may be fabricated out of heavy gauge welded steel, sheet metal or other suitable material. It may customarily be built-in to new construction as an attachment to the exterior wall of the home or business. It may, however, be just as suitable for retrofitting into existing construction. The cabinet may have a single secure exterior access door, or double doors: a secure door on the exterior wall of the building and an unsecured or optional secure door on the interior wall of the building. The building occupant may typically install it at a height that is convenient for the Delivery Person and retrieval by the User. In some applications, heated, cooled or other environmentally controlled cabinets may be installed. The cabinet may also be a freestanding unit that would resemble a U.S. Mail or FedEx deposit box.

The cabinet's size and use is suitable for, but not limited to, the unattended delivery and secure storage of U.S. mail, mail order consumer goods packages, overnight and courier document packages, home delivery meals, or home delivery groceries. The size may be large enough to accommodate a typical size box from a mail order company, a delivery of dry cleaning on hangers, a few sacks of groceries, or several large boxes of pizza. One typical interior measurement of the storage area is 24″ deep×24″ high×24″ wide. The size of the appliance 24 may additionally vary from small units that can only accommodate a few books to very large units that can be as large a several hundred square feet. The User or building occupant may finish the interior side of the storage appliance with a veneer to coordinate with the interior decor. However, the cabinet may also be offered with a factory finish.

In these secure delivery appliance applications, one-time use access codes may be assigned to delivery Authorized Persons like FedEx and UPS drivers to deliver packages. The Host 16 via an Internet browser, EDI, voice messaging, text messaging, wireless mobile device, email or any other suitable electronic communication method, may transmit authorized codes and applicable usage information to the Authorized Person or delivery company. The access code, and other relevant messages are associated with their tracking number and transmitted to the delivery driver or printed on shipping labels.

Additionally, the secure delivery appliance 24 could be built as a combination of a United States Postal Service (“USPS”) mailbox and a general delivery appliance accessed by other non-USPS delivery persons. This embodiment has one compartment that is accessed only by the USPS postman and another that is accessed by other delivery persons. In this embodiment, the U.S. Mail is also left in a secure delivery receptacle and is secured by a locking mechanism accessible only by an authorized person. This will mitigate the risks of identity theft and other mail theft inherent with nun-secure mail delivery.

For nonrecurring deliveries like pizza, the User has the ability to remotely create a valid one-time use code at a remote location 26, such as the office, for home delivery and transmit it to the Authorized Person while ordering by telephone, by voice message, text message or email.

There may also be other recurring deliveries such as the paperboy who might be given a code that is valid only on Monday through Saturday from 4:00 pm to 7:00 pm and on Sunday mornings from 5:00 am to 8:00 am with no limit to the duration date.

The Delivery Person can ask the User to authorize his or her own preferred familiar code. For example the paperboy might prefer that all delivery boxes in a given neighborhood be the same code, 1776.

The dry cleaners may be given a code that is valid from 8:00 am to 5:00 pm on weekdays only.

The User might also leave special tools or chemicals in the delivery box for the lawn or swimming pool service whose access schedule is every 2^{nd} Thursday between 2:00 pm and 5:00 pm and such access being limited to those times.

A contractor who will be on location for one month may need access to the delivery box during his time on the job site. His access code can be limited to Monday through Saturday, 7:00 am to 6:00 pm, valid from Nov. 5, 2005 through Dec. 4, 2005.

A cable guy may be scheduled to drop off a new channel receiver box at exactly 1:15 pm on Tuesday Nov, 29, 2005. Of course the User would need to authorize his one-time code from 3:00 am to 11:00 pm on the 28^{th}, 29^{th} and 30^{th}.

Security Doors

Another common application of the invention is access points 12 that may be security doors to residential, office, commercial or government buildings. Each individual building tenant may be given a unique access code that is valid at all times but may be terminated on the expiration date of his or her lease or employment.

Some office buildings might prefer an option to open the locking mechanism 12 without a code being required for a given period of time but require secure authorized entry at other times. For example, the access point 12 may be a front door to the unattended lobby of an office building which remains unlocked from 8:00 am to 6:00 on Monday through Friday, but requires authorized access at all other times.

Also, contract employees can be given unique codes that are limited to their respective work hours and durations of the job.

Employees can be assigned unique codes that that are valid only during their respective working hours. These codes would have indefinite durations and could be suspended or deleted when that employee is on vacation or terminated. The Host system 16 usage report 17 and 20 would also serve as a substitute for a time clock for verification of employee tardiness or absenteeism.

Similar groups of employees can all be given access codes in a series. For example, all members of the machinist union could be given codes that begin with 8600-****. If for some reason a User had to suspend all 700 of them all at once, this is easily done with the user interface.

Pedestrian and Vehicle Gates

Another application of the invention is an access point 12 being pedestrian and vehicle gates to restricted areas such as airports, gated neighborhoods, or industrial areas.

At general aviation airports, there are usually several hundred pilots, students, mechanics and aircraft owners who have authorized business on the airport property. New Homeland Security measures require enhanced security and limited access to aircraft areas. Here, unique authorization codes without time of day limits can be assigned and easily deleted, modified or suspended by the airport security administrator, for access to an airport access point 12.

Gated residential or resort communities are also common applications of the invention. Residents can each be given unique unlimited access codes and easily deleted when they move. Property owner association variable fees that are based upon days on the property can be conveniently tracked using the Host reporting system. Visitors and guest access codes can be limited to the duration of their stay. Realtors can be given codes limited to the duration of their property listings.

Industrial areas also have the need for tracking and authorizing secure traffic. These Authorized Persons can be given access codes with appropriate time and duration limits. Truck drivers in many industries such as oil field, timber, sand & gravel haulers are paid by the load regardless of weight or volume. Here also, The Host reporting system can track the time, date and frequency of these drivers access to the authorization point 12.

Locked Mechanisms, Control Consoles, Valves and Switches

There may also be applications of access point 12 such as a real estate agent's lock box for securely enclosing a door key to a listed property. In this embodiment, a front door key is securely locked in an appliance that is accessible to a real estate agent who has been given a valid access code. Typically, this is a small box that is attached to the exterior door of a home or other property that is listed for sale. The showing agent usually needs this key to access the property for a showing to a potential purchaser. The tracking functionality will also give the listing agent and property owner a previously unavailable ability to verify the exact time a particular Authorized real estate agent accessed a property.

Other access points 12 may include access to locked mechanisms such as control consoles, valves and switches. As in the examples above, the present invention provides authorized access to these devices with limits and tracking on the Authorized Persons and the appropriate days, dates, times and recurrences of their access.

Problem Solved

Value Proposition to the User

The User of the remotely managed locking mechanism may be given the ability to have a wide range of robust day, date, time, recurrence and duration authorization options for multiple access codes. These embodiments of access point 12 may be a secure delivery appliance, secure door or gate, or locked mechanisms such as valves, switches or control consoles.
a. The authorized User can assign an unlimited number of codes. These codes are essentially numeric passwords that can be any length of characters the User desires.
b. The authorized User can assign an authorized code that is valid on an unlimited number of access points.
c. The management system can optionally assign randomly generated access codes like a “quick pick” if the User wants this convenience.
d. Each code or group of codes can have varying time durations of validity. For example one day, week, month or year starting from the time of first use regardless of when that first use occurs.
e. Each code or group of codes can have finite date and time durations of validity. For example from exactly 7:15 am on the Sep. 10, 2005 to exactly 12:00 midnight on Oct. 15, 2005.
f. Each code or group of codes can have varying time periods of indefinite validity. For example from 9:00 am to 5:00 pm on weekdays only with no ending date.
g. Each code or group of codes can have a varying number of recurrences to authorized use. This could be limited to a one-time only use or for example to exactly 52 uses.
h. Each code or group of codes can have recurrences of authorized use to varying days, weeks, months, or years. For example, every Tuesday, every 3^{rd} Monday of the month, every 15^{th} of month, or every February the 14^{th}.
i. Any code or group of codes can easily be modified, suspended or deleted. For example when an employee is on vacation, is terminated, when a contractor is finished with his work or an authorized resident moves.

For the homeowner, property manager or security personnel (“User”), applications with the secure delivery appliance provides a solution to the need to receive unattended deliveries via a weatherproof and secure storage cabinet.

The User of secure delivery appliance 12 may be given a solution to unattended “Signature Required” deliveries. The use of an authorized code by a Delivery Person will be an acceptable substitute for proof of delivery and may provide notification and a tracking mechanism for the time of delivery.

The User can manage access remotely 26 via the Internet through a common browser interface, or by a wireless communication network via mobile device 31 to the Host system 16. In this way, the User can grant access from a remote office 26, while on vacation, or with a mobile telephone.

The User and Authorized Persons 30 may be given a reporting mechanism to track use and delivery times that also offers instant notification via the internet or a wireless communication network via a wireless mobile device . This reporting capability could include the code used, time, date, location, audio, video or other recorded multimedia data and is applicable whether the access point 12 is a locked mechanism or is not locked.

Value Proposition to the Authorized Person

Here, the (“Authorized Person”) includes but is not limited to, a tenant, contractor, employee, invitee, merchant or Delivery Person. (“Delivery Person”) includes, but is not limited to companies such as FedEx, UPS, DHL, U.S. Postal Service, couriers, home delivery groceries, the paper boy, pizza delivery, or dry cleaners.

When the application of the invention is a secure delivery appliance, the Delivery Person will always have a weatherproof and secure place to leave deliveries and will not have the concern of damaged or stolen goods.

The Delivery Person may be given a solution to unattended “signature required” deliveries. As stated above, the use of an authorized code at 14 by a Delivery Person may be an acceptable substitute for proof of delivery. This may eliminate the occurrences of “no one home” and the resulting undelivered item. The benefit is no wasted delivery time, additional tracking, additional package handling, less after hours payroll at the local shipping service office, and returns to the sender.

As with some other arrangements, the Authorized Person will not be required to carry a key.

The Host 16 provides a tracking mechanism that will instantly confirm the time of delivery or use of the access point 12.

With widespread acceptance of the invention, mail order companies and shippers will be able to use common EDI text fields for access codes. In the meantime, simple text in the memo field will do. For example, shipping labels may include text such as, “Delivery box access code: 3006”.

The Authorized Person can ask the User to authorize his or her own preferred familiar code. For example the paperboy might prefer that all secure delivery boxes in a given neighborhood be the same code, 1776.

The Authorized Person can have a single code that is valid on an unlimited number of access points. Here again, this is applicable to the apartment building superintendent who needs a single valid code to access all of the units in a building.

With the application of a bar code scanner, magnetic card reader, an RFID receiver or other such electronic receiver on the lock control mechanism, the Authorized Person may not be required to do anything to open the access point.

Sample Data Tables

The Host System is managed in a relational database architecture. The following Table 1 represents a data sample which tracks usage at each individual access point. Each combination of Device EID and Authorized Access Code will be associated with a unique User ID#. The access point EID is the unique electronic ID number assigned to each respective access point mechanism. Line 1 of Table 1 illustrates the data captured by the Host system for a single occurrence of a use of the system.

TABLE 1
Global Activity Statement

| | | | | Access |
|---|---|---|---|---|
| Line | Access | | | Autho- |
| # | Point EID | Code used | Date & Time of Use | rized? |
| 1 | 894915 | 10546403 | Mar. 21, 2006 15:09:12 | Yes |
| 2 | 917483 | 11354581 | Mar. 16, 2006 9:52:24 | Yes |
| 3 | 940051 | 1600324 | Mar. 19, 2006 23:18:48 | Yes |
| 4 | 962619 | 18731515 | Mar. 14, 2006 20:48:43 | Yes |
| 5 | 985187 | 18849847 | Mar. 19, 2006 23:18:48 | Yes |
| 6 | 999555 | 3006 | Mar. 1, 2006 15:15:24 | Yes |
| 7 | 999555 | 6345789 | Mar. 2, 2006 14:31:47 | Yes |
| 8 | 999555 | 3006 | Mar. 2, 2006 15:13:54 | Yes |
| 9 | 999555 | 3006 | Mar. 3, 2006 15:14:08 | Yes |
| 10 | 999555 | 3006 | Mar. 4, 2006 15:10:31 | Yes |
| 11 | 999555 | 3006 | Mar. 5, 2006 15:15:22 | Yes |
| 12 | 999555 | 3006 | Mar. 6, 2006 14:00:06 | Yes |
| 13 | 999555 | 3006 | Mar. 7, 2006 14:31:47 | Yes |
| 14 | 999555 | 3006 | Mar. 8, 2006 15:15:58 | Yes |
| 15 | 999555 | 3006 | Mar. 9, 2006 15:15:25 | Yes |
| 16 | 999555 | 222333 | Mar. 10, 2006 15:15:24 | Yes |
| 17 | 999555 | 1492 | Mar. 10, 2006 15:15:25 | No |
| 18 | 999555 | 1941 | Mar. 10, 2006 15:16:00 | No |
| 19 | 999555 | 1776 | Mar. 10, 2006 15:16:35 | No |
| 20 | 999555 | 1984 | Mar. 11, 2006 7:15:25 | Yes |
| 21 | 999555 | 222333 | Mar. 11, 2006 15:13:54 | Yes |
| 22 | 999555 | 222333 | Mar. 12, 2006 15:14:08 | Yes |
| 23 | 999555 | 6345789 | Mar. 12, 2006 20:44:25 | Yes |
| 24 | 999555 | 222333 | Mar. 13, 2006 15:10:31 | Yes |
| 25 | 999555 | 222333 | Mar. 14, 2006 0:00:00 | Yes |
| 26 | 999555 | 6345789 | Mar. 28, 2006 15:15:22 | Yes |
| 27 | 1000580 | 11058183 | Mar. 18, 2006 17:55:22 | Yes |
| 28 | 1001580 | Null | Mar. 18, 2006 19:55:22 | Yes |
| 29 | 1001605 | 16051213 | Mar. 16, 2006 18:10:46 | Yes |
| 30 | 1002630 | 18783900 | Mar. 15, 2006 14:57:00 | Yes |
| 31 | 1003655 | 3862582 | Mar. 21, 2006 23:35:05 | Yes |
| 32 | 1004680 | 6006172 | Mar. 15, 2006 2:16:21 | Yes |
| 33 | 1005705 | RFID-12016954 | Mar. 29, 2006 19:35:48 | Yes |
| 34 | 1006730 | 9066030 | Mar. 27, 2006 21:15:56 | Yes |
| 35 | 1007755 | 7425552 | Mar. 26, 2006 19:18:22 | Yes |

In this line 1 example, we will assume that this access point is for a secure delivery storage appliance. The unique EID for this particular appliance is “894915”. A person entered the code “10546403” at 3:09 PM on Mar. 21, 2006. The system confirmed this as a valid code for this access point and additionally validated the date, time and recurrence limitations for the use of this code at this time and place and thus allowed access denoted by the “Yes” field in that record.

Line 6 through line 26 shows a range of activity at access point “999555”. The range of activity is Mar. 1, 2006 through Mar. 28 2006. The activity shows a variety of codes used and the date and time of each use. Note lines 17 through 19. In this example, an unauthorized user attempted to access the unit by entering familiar dates as access codes. In these three attempts, the system denied access as denoted by the “No” field in those three records.

Also note the data record in line 28. In this example, the locking mechanism was opened even though no code was entered at the access point. In this case, the system tracked the occurrence of a single opening of an access point without the need of a valid code. This situation is applicable where the User wants to track usage at an unsecured point such as a doorway to a public place.

Additionally, note the data record in line 33 of Table 1. This field shows an occasion where the locking mechanism was opened of the by the use of an authorized RFID method, or other similar electronic method, as opposed to a manually entered code.

Table 2 shows the data table for a single device with the unique EID of “999555” shown on line 2. Line 3 has text showing the location of this device. Line 6, 7 & 8 shows that there are three Users for this device. This would be the case with three building tenants with a common access point such as a doorway. Lines 9 through 23 show a list of unique authorized codes associated with the respective User who has permission to manage that unique code.

TABLE 2
Table 2 - Access Point Data Record

| Line # | | | |
|---|---|---|---|
| 1 | | | |
| 2 | Device EID | 999555 | |
| 3 | Device Location | 75205 | 921 E Commerce |
| | | | Street, Dallas, Texas |
| | | | 75205, SW Corner of |
| | | | the front porch |
| 4 | | | |
| 5 | Authorized | | |
| | User ID | | |
| 6 | User ID | 8884 | |
| 7 | User ID | 56879 | |
| 8 | User ID | 77795 | |
| 9 | | Authorized User ID | Unique Codes |
| 10 | | 8884 | 1984 |
| 11 | | 56879 | 2133 |
| 12 | | 8884 | 3006 |
| 13 | | 56879 | 3155 |
| 14 | | 8884 | 222333 |
| 15 | | 56879 | 222482 |
| 16 | | 8884 | 852485 |
| 17 | | 56879 | 852634 |
| 18 | | 8884 | 5875125 |
| 19 | | 77795 | 5875274 |
| 20 | | 8884 | 6345789 |
| 21 | | 56879 | 6345938 |
| 22 | | 8884 | 6758504 |
| 23 | | 77795 | 6758653 |

Table 3 shows the data associated with a particular User. Line 2 is the unique User ID # for this User. Lines 3 through 14 show the contact and billing information for this User. Line 16 shows one device EID associated with this User. Lines 18 through 24 shows unique Authorized Codes associated with this User and Device EID combination. Note that this user could have multiple Device EID and associated unique Authorized Code combinations but only one set is illustrated here.

TABLE 3
Table 3 - User Data Record

| Line # | | |
|---|---|---|
| 1 | | |
| 2 | User ID | 8884 |
| 3 | Name | John Q. Smith |
| 4 | Address 1 | 123 Main Street |
| 5 | Address 2 | Suite 201 |
| 6 | City | Dallas |
| 7 | State | TX |
| 8 | Zip | 75209 |
| 9 | Country | USA |
| 10 | Phone Number 1 | 214-520-8989 |
| 11 | Phone Number 2 | 214-750-4512 |
| 12 | Mobile Phone | 972-288-4305 |
| 13 | Email 1 | JohnQ@MailServ.com |
| 14 | Email 2 | JQS3006@POPMail.com |
| 15 | | |
| 16 | Device EID | 999555 |
| 17 | | Authorized Codes |
| 18 | Me | 3006 |
| 19 | Housekeeper | 6345789 |
| 20 | Billy the Painter | 1984 |
| 21 | Paper Boy | 222333 |
| 22 | Pool Service | 852485 |
| 23 | Fed-Ex package | 5875125 |
| | 80199978522485565 | |
| 24 | Pizza Delivery | 6758504 |

Each User ID, device EID and Authorized Code combination will have applicable time, date and recurrence limitations associated with it. Table 4 illustrates the first hierarchy of the range of recurrence for a unique code combination. In this Table, all data records are associated with the Table 4 Device EID #999555 for User #8884.

TABLE 4
Table 4 - Range of Reccurance

| Line # | | | Start | End | Lock Open | | | | |
|---|---|---|---|---|---|---|---|---|---|
| 1 | Start Date | End Date | Time | Time | Duration | Reccurances | Used | Remaining | Code |
| 2 | any | any | any | any | 10 Seconds | any | any | any | 3006 |
| 3 | 1 Jan. 2006 | 31 Dec. 2006 | 7:30 AM | 5:30 PM | 10 Seconds | any | any | any | 6345789 |
| 4 | 15 Mar. 2006 | 15 Apr. 2006 | 9:00 AM | 6:00 PM | 10 Seconds | any | any | any | 1984 |
| 5 | 15 Feb. 2004 | any | 6:00 AM | 8:00 AM | 10 Seconds | any | any | any | 222333 |
| 6 | any | any | any | any | 8 Hours | 52 | 13 | 39 | 852485 |
| 7 | any | any | any | any | 10 Seconds | 1 | 0 | 1 | 5875125 |
| 8 | Today Only | Today Only | any | 8:15 PM | 10 Seconds | 1 | 1 | 0 | 6758504 |

Line 2 shows a data record that would likely be set up for the User only. In this example, “any” range of dates is authorized, for “any” time of day and with “any” number of occurrences of usage. In other words, Code 3006 is used by the owner and there are no limitations on that code's usage.

Line 3 shows a code “6345789” that is assigned to the “Housekeeper” from Table 3 above. This code is valid only during the calendar year 2006, and only from 7:30 am to 5:30 pm. Upon use, the lock will stay open for 10 seconds. There is no limit to the number of occurrences of use.

Line 4 shows a code “1984” that is assigned to the “Billy the Painter” from Table 3 above. This code is valid only during from Mar. 15, 2006, through Apr. 15, 2006 and only from 9:00 am to 6:00 pm. Upon use, the lock will stay open for 10 seconds. Again, there is no limit to the number of occurrences of use during this timeframe.

The “Paperboy” #222333 is given access beginning on Feb. 15, 2004 with no termination date but only from 6:00 am to 8:00 am.

The “Pool service” #852485 is given access for 8 hours for any period of time they show up but this is limited to 52 visits of which they have used 13 and have 39 remaining.

Fed-Ex package 80199978522485565 has an access code #5875125 which is valid at any time for a one time use only.

The Pizza delivery code #6758504 is good for a one time use, Today only, with no start time but terminating at 8:15 pm if they don't deliver the pepperoni with anchovies by then.

Table 5 shows optional recurrence patterns that can additionally be associated with each code from table 4. In this way, each code has a valid range of time or recurrence from table 4 and may further have a recurrence pattern valid only on certain days, dates, weeks, months or years.

TABLE 5
Table 5 - Optional Reccurance patterns

| Line # | | | | | | | | |
|---|---|---|---|---|---|---|---|---|
| 1 | Daily | | | | | | | |
| 2 | Every # days | | | | | | | |
| 3 | 1 | | | | | | | |
| 4 | 2 | | | | | | | |
| 5 | | | | | | | | |
| 6 | (or) | | | | | | | |
| 7 | | | | | | | | |
| 8 | Every Weekday | | | | | | | |
| 9 | Yes | | | | | | | |
| 10 | No | | | | | | | |
| 11 | | | | | | | | |
| 12 | (or) | | | | | | | |
| 13 | | | | | | | | |
| 14 | Every Saturday & | | | | | | | |
| | Sunday | | | | | | | |
| 15 | Yes | | | | | | | |
| 16 | No | | | | | | | |
| 17 | | | | | | | | |
| 18 | (or) | | | | | | | |
| 19 | | | | | | | | |
| 20 | Weekly | | | | | | | |
| 21 | Recur Every # Weeks | Sun | Mon | Tues | Wed | Thurs | Fri | Sat |
| 22 | 1 | No | Yes | Yes | Yes | Yes | Yes | No |
| 23 | 2 | No | Yes | No | Yes | No | Yes | No |
| 24 | | | | | | | | |
| 25 | (or) | | | | | | | |
| 26 | | | | | | | | |
| 27 | Monthly By Date | | | | | | | |
| 28 | Day | Every # Month(s) | | | | | | |
| 29 | 20th | 2 | | | | | | |
| 30 | 15th | 1 | | | | | | |
| 31 | 30th | 1 | | | | | | |
| 32 | | | | | | | | |
| 33 | (or) | | | | | | | |
| 34 | | | | | | | | |
| 35 | Monthly by Day | | | | | | | |
| 36 | the # | Day | of every # Month | | | | | |
| 37 | 3rd | Friday | 1 | | | | | |
| 38 | 1st | Monday | 1 | | | | | |
| 39 | Last | Friday | 2 | | | | | |
| 40 | | | | | | | | |
| 41 | (or) | | | | | | | |
| 42 | | | | | | | | |
| 43 | Yearly By Date | | | | | | | |
| 44 | Day | of Month | | | | | | |
| 45 | 26th | August | | | | | | |
| 46 | 12th | February | | | | | | |
| 47 | 6th | September | | | | | | |
| 48 | | | | | | | | |
| 49 | (or) | | | | | | | |
| 50 | | | | | | | | |
| 51 | Yearly by Day | | | | | | | |
| 52 | the # | Day | of Month | | | | | |
| 53 | 3^{rd} | Friday | August | | | | | |
| 54 | first | Monday | September | | | | | |
| 55 | Last | Tuesday | April | | | | | |

Table 5 Line 3 shows a recurrence of every day.

Table 5 Line 4 shows a recurrence of every other day.

Table 5 Line 9 shows a recurrence of every weekday only.

Table 5 Line 15 shows a recurrence of every Saturday and Sunday.

Table 5 Line 22 shows a recurrence of every week on Monday, Wednesday & Friday only.

Table 5 Line 23 shows a recurrence of every 2nd week on Monday, Wednesday & Friday only.

Table 5 Line 29 shows a recurrence of every 2^{nd} month on the 20^{th} of that month.

Table 5 Line 30 shows a recurrence of each month on the 15^{th} of the month.

Table 5 Line 31 shows a recurrence of each month on the 30^{th} of the month.

Table 5 Line 37 shows a recurrence of each month on the 3^{rd} Friday of the month.

Table 5 Line 38 shows a recurrence of each month on the 1^{st} Monday of the month.

Table 5 Line 39 shows a recurrence of each last Friday of every 2^{nd} month.

Table 5 Line 45 shows a recurrence of once each year on the 26^{th} of August.

Table 5 Line 53 shows a recurrence of once each year on the 3^{rd} Friday of August.

Table 5 Line 54 shows a recurrence of once each year on the 1^{st} Monday of September.

Table 5 Line 54 shows a recurrence of once each year on the last Tuesday of April.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A controlled access point system, comprising:
an access point;
a host physically remote from the access point and operatively coupled thereto via a first communication link; and
a data entry module physically remote from the access point and the host, enabled for use by a user and configured to communicate with the host via a second communication link and selectively control access by a third party to the access point.

2. The system as specified in claim 1 wherein the first communication link is the internet or wireless communication network.

3. The system as specified in claim 2 wherein the data entry module is enabled to provide the selectively controlled access via the internet or wireless communication network.

4. The system as specified in claim 1 wherein the data entry module is enabled to provide at least one valid access code to the host, wherein the host accepts the valid access codes and responsively controls the access point as a function of an access code provided to the access point by the third party.

5. The system as specified in claim 1 wherein the data entry module is enabled to provide at least one valid access code to the access point, wherein the access point accepts the valid access codes and responsively permits access to the access point, upon detecting the valid access code provided thereto by the third party.

6. The system as specified in claim 1 wherein the access point is configured to report activity at the access point to the host.

7. The system as specified in claim 6 wherein the host is configured to provide a report indicative of the access point activity.

8. The system as specified in claim 7 wherein the report is configured to be accessible by the user via the second communication link.

9. The system as specified in claim 8 wherein the report is configured to be accessible by the user via the internet or wireless communication network.

10. The system as specified in claim 7 wherein the report includes data indicative of an access code entered by the third party as a function of the access point activity.

11. The system as specified in claim 4 wherein the access point includes a lock enabled to be controlled as a function of the access codes.

12. The system as specified in claim 5 wherein the access point includes a lock enabled to be controlled as a function of the access codes.

13. The system as specified in claim 4 wherein the access point includes a storage receptacle enabled to be controlled as a function of the access codes.

14. The system as specified in claim 5 wherein the access point includes a storage receptacle enabled to be controlled as a function of the access codes.

15. The system as specified in claim 1 wherein the first communication link comprises a wireless link.

16. The system as specified in claim 1 wherein the second communication link comprises a wireless link.

17. The system as specified in claim 1 wherein the second communication link comprises the internet or a wireless communication network.

18. The system as specified in claim 4 wherein at least one said access code is a vendor code.

19. The system as specified in claim 5 wherein at least one said access code is a vendor code.

20. The system as specified in claim 1 wherein the access point is configurable to allow access without receiving an access code for a predetermined period.

21. The system as specified in claim 20 wherein the host is enabled to configure the access point to allow access without an access code being provided by the third party for a predetermined period.

22. The system as specified in claim 4 wherein the host is enabled to provide a geographical location of the access point and at least one said valid access code to the third party.

23. The system as specified in claim 5 wherein the host is enabled to provide a geographical location of the access point and at least one said valid access code to the third party.

24. The system as specified in claim 4 wherein the at least one valid access code is valid for a predetermined number of uses by a third party at the access point.

25. The system as specified in claim 5 wherein the at least one valid access code is valid for a predetermined number of uses by a third party at the access point.

26. An access point, comprising:
an actuator configured to unlock in response to entry of a valid access code provided thereto by a third party, further configured to compare an access code provided by the third party to a valid access code provided by a physically remote host via an internet connection, or wireless communication network valid access codes being established by a physically remote user.

27. The access point of claim 26 further including an electronic identification number (EID) enabled such that the host can access the EID.

28. The access point of claim 26 wherein the access point further includes memory configured to store the valid access codes.

29. The access point of claim 26 wherein the access point is enabled to receive a code by the third party and validate the code with the host, the actuator configured to unlock upon said validation.

30. The access point of claim 26 wherein the access point includes a keypad configured to receive entry of the access code from the third party.

31. The access point of claim 26 wherein the access point includes a biometric reader, magnetic card reader, RFID receiver, bar code scanner, or other such electronic receiver configured to receive entry of the access code from the third party.
